(19) United States
(12) Patent Application Publication
(10) Pub. No.: US 2021/0190903 A1
(43) Pub. Date: Jun. 24, 2021

(54) RADAR APPARATUS AND SIGNAL PROCESSING METHOD

(71) Applicant: Mitsubishi Electric Corporation, Tokyo (JP)

(72) Inventor: Satoshi KAGEME, Tokyo (JP)

(73) Assignee: Mitsubishi Electric Corporation, Tokyo (JP)

(21) Appl. No.: 17/176,473

(22) Filed: Feb. 16, 2021

Related U.S. Application Data
(63) Continuation of application No. PCT/JP2018/040827, filed on Nov. 2, 2018.

(51) Int. Cl. G01S 7/282; G01S 13/06; G01S 13/58; G01S 7/285

(52) U.S. Cl. CPC G01S 7/282; G01S 7/285; G01S 13/58; G01S 13/06

(57) ABSTRACT

A radar apparatus includes: a PRI control unit for setting a plurality of pairs of a pulse repetition interval longer than a reference interval and a pulse repetition interval shorter than the reference interval; a signal generation circuit for generating a plurality of transmission pulse signals on the basis of the plurality of pairs of pulse repetition intervals; a transmission and reception unit for sending out the plurality of transmission pulse signals to external space and receiving a plurality of reflected wave signals from the external space; a receiving circuit for generating a plurality of received signals by sampling each of the plurality of reflected wave signals; a signal conversion unit for generating a plurality of frequency domain signals by performing domain conversion processing from a time domain to a frequency domain on the plurality of received signals; and a target detection unit for detecting a target candidate on the basis of the plurality of frequency domain signals.

### CROSS-REFERENCE TO RELATED APPLICATIONS

This application is a Continuation of PCT International Application No. PCT/JP2018/040827, filed on Nov. 2, 2018, all of which is hereby expressly incorporated by reference into the present application.

### TECHNICAL FIELD

The present invention relates to a radar technique for detecting a target such as a mobile object, and more particularly to a radar technique for detecting a target by signal processing including coherent integration.

### BACKGROUND ART

A general pulse Doppler radar can transmit a plurality of pulse waves on the basis of a pulse repetition interval (PRI), then receive a plurality of reflected waves corresponding to the plurality of pulse waves from a target to generate a plurality of received signals, and estimate relative velocity (target velocity) of the target on the basis of the plurality of received signals.

Among such pulse Doppler radars, there is known one that adopts a pulse-to-pulse stagger method in which transmission intervals of pulse waves are made unequal for the purpose of improving target detection performance. However, in the pulse-to-pulse stagger method, a pulse repetition interval is not constant. As a result, a phase change occurs in a received signal, and energy loss (integration loss) may occur during coherent integration. Patent Literature 1 (Japanese Unexamined Patent Publication No. 6-294864) discloses a pulse Doppler radar capable of avoiding occurrence of loss when coherent integration is performed on a received signal (received video signal), even if the radar is operated by the pulse-to-pulse stagger method. The pulse Doppler radar disclosed in Patent Literature 1 avoids occurrence of integration loss by predicting a phase change of the received signal from a value of a pulse repetition interval and a value of target velocity and correcting a phase of the received signal using a result of the prediction.

### CITATION LIST

### Patent Literature

Patent Literature 1: Japanese Unexamined Patent Publication No. 6-294864 (see, for example, FIG. 1)

### SUMMARY OF INVENTION

### Technical Problem

As described above, the pulse Doppler radar disclosed in Patent Literature 1 requires the value of the target velocity in order to correct the phase of the received signal. Therefore, when detection of the target velocity fails, or when detection accuracy of the target velocity is low, there is a problem that integration loss occurs and target detection performance is deteriorated.

In view of the above, an object of the present invention is to provide a radar apparatus and a signal processing method for suppressing integration loss and improving target detection performance without requiring a value of target velocity.

### Solution to Problem

A radar apparatus according to one aspect of the present invention including: processing circuitry to set a plurality of pairs of a pulse repetition interval longer than a predetermined reference interval and a pulse repetition interval shorter than the reference interval; continuously generate a plurality of transmission pulse signals at a timing based on the plurality of pairs of pulse repetition intervals; send out the plurality of transmission pulse signals to external space and receiving a plurality of reflected wave signals corresponding to the respective plurality of transmission pulse signals from the external space; generate a plurality of received signals corresponding to the respective plurality of transmission pulse signals by sampling each of the plurality of reflected wave signals having been received; generate a plurality of frequency domain signals by performing domain conversion processing from a time domain to a frequency domain on the plurality of received signals; and detect a target candidate on the basis of the plurality of frequency domain signals.

### Advantageous Effects of Invention

According to the one aspect of the present invention, the plurality of pairs of the pulse repetition interval longer than the predetermined reference interval and the pulse repetition interval shorter than the reference interval is set, so that the signal conversion unit can suppress integration loss when performing the domain conversion processing without requiring a value of target velocity. Thus, it is possible to improve target detection performance.

### BRIEF DESCRIPTION OF DRAWINGS

FIG. 1 is a block diagram showing a schematic configuration of a radar apparatus according to a first embodiment of the present invention.

FIG. 2 is a block diagram schematically showing a configuration example of a signal generation circuit in the first embodiment.

FIG. 3 is a graph showing a setting example of a pulse repetition interval.

FIG. 4 is a graph showing another setting example of the pulse repetition interval.

FIG. 5 is a block diagram schematically showing a configuration example of a receiving circuit in the first embodiment.

FIG. 6 is a flowchart schematically showing an operation procedure of a radar signal processing circuit in the first embodiment.

FIG. 7A is a diagram schematically showing an example of a phase state of pulse compression signals obtained when it is assumed that all pulse repetition intervals are set to the same value, and FIG. 7B is a diagram schematically showing an example of a phase state of pulse compression signals obtained when the pulse repetition intervals according to the first embodiment are set.

FIG. 8 is a graph schematically showing an example of spectra of three types of frequency domain signals.

FIG. 9 is a block diagram showing a hardware configuration example that implements functions of a PRI control unit and the radar signal processing circuit in the first embodiment.

FIG. 10 is a block diagram schematically showing a configuration of a radar apparatus according to a second embodiment of the present invention.

FIG. 11 is a diagram showing a relationship between a pulse compression signal and the pulse repetition interval in the first embodiment.

FIG. 12 is a diagram for explaining oversampling processing in the second embodiment.

FIG. 13 is a flowchart schematically showing an operation procedure of a radar signal processing circuit in the second embodiment.

FIG. 14A is a diagram schematically showing an example of spectra of frequency domain signals generated in the first embodiment, and FIG. 14B is a diagram schematically showing an example of a spectrum of a frequency domain signal generated in the second embodiment.

FIG. 15 is a diagram schematically showing a configuration of a radar apparatus according to a third embodiment of the present invention.

FIG. 16 is a diagram schematically showing a configuration of a radar apparatus according to a fourth embodiment of the present invention.

FIG. 17 is a schematic configuration diagram of a signal generation circuit in the fourth embodiment.

### DESCRIPTION OF EMBODIMENTS

Hereinafter, various embodiments of the present invention will be described in detail by referring to the drawings. It is to be noted that components denoted by the same reference numerals throughout the drawings have the same configuration and the same function.

### First Embodiment

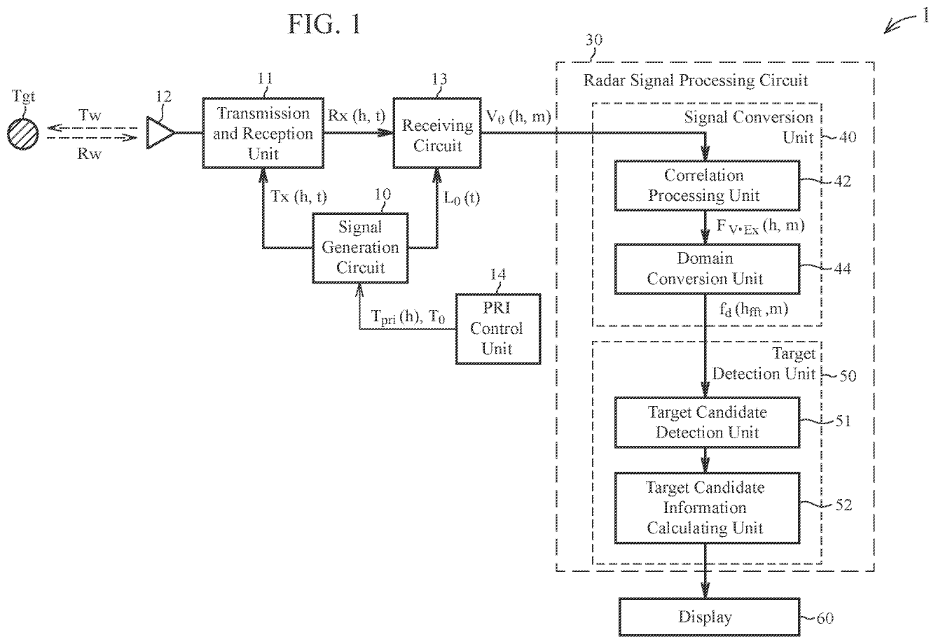

FIG. 1 is a block diagram showing a schematic configuration of a radar apparatus 1 according to a first embodiment of the present invention. As shown in FIG. 1, the radar apparatus 1 includes: a signal generation circuit 10 that generates a plurality of transmission pulse signals Tx(h,t) at a timing based on pulse repetition intervals (PRIs) Tₚᵣᵢ(h); a transmission and reception unit 11 that outputs the plurality of transmission pulse signals Tx(h,t) to an antenna (aerial) 12 and then receives a plurality of reflected wave signals Rx(h,t) corresponding to the respective plurality of transmission pulse signals Tx(h,t); a receiving circuit 13 that performs analog signal processing on the plurality of reflected wave signals Rx(h,t) to generate a plurality of received analog signals W₀(h,t) and converts the respective plurality of analog signals W₀(h,t) into a plurality of received digital signals (received video signals) V₀(h,m); a radar signal processing circuit 30 that performs digital signal processing on the plurality of received digital signals V₀(h,m) and detects a target candidate; and a display 60 that displays a result of the detection.

Further, the radar apparatus 1 includes a PRI control unit 14 that sets the pulse repetition interval Tₚᵣᵢ(h) used in the signal generation circuit 10. As a frequency band used by the radar apparatus 1, for example, a frequency band such as a millimeter wave band or a microwave band can be used.

For the transmission pulse signal Tx(h,t), the reflected wave signal Rx(h,t), and the received analog signal W₀(h,t), a variable t represents time, a variable h is an integer in the range of 0 to H−1 representing a pulse hit number, and H is the number of pulse hits. Hereinafter, the pulse hit number h is referred to as a “hit number h”. Further, a variable m in the received digital signal V₀(h,m) is an integer in the range of 0 to M(h)−1 representing a sampling number, and M(h) is a sampling point related to the hit number h.

The antenna 12 can radiate transmission waves Tw based on the transmission pulse signals Tx(0,t) to Tx(H−1,t) to external space, and then receives reflected waves Rw returned from the external space. The transmission and reception unit 11 outputs reflected wave signals Rx(0,t) to Rx(H−1,t) based on reception output of the antenna 12 to the receiving circuit 13.

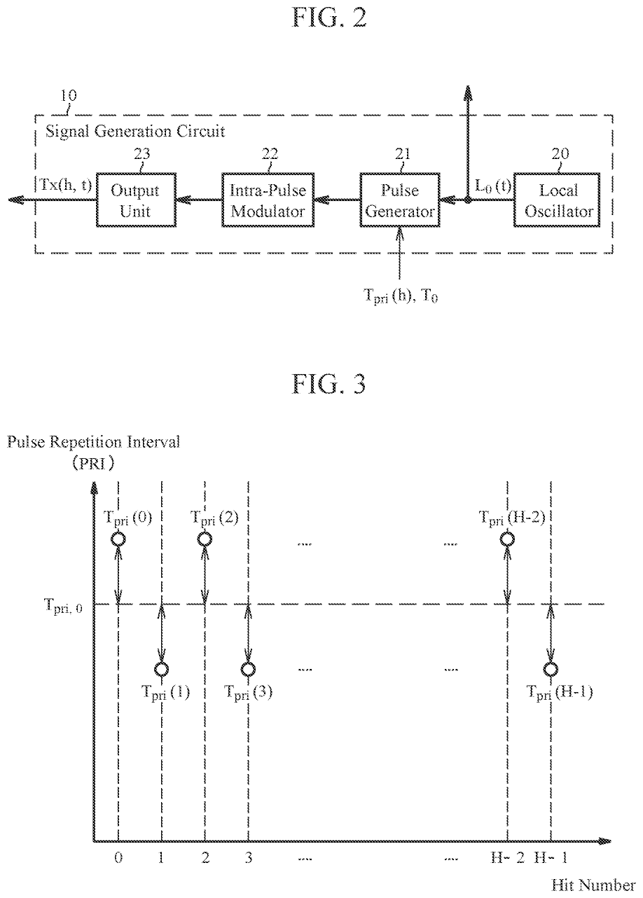

FIG. 2 is a block diagram schematically showing a configuration example of the signal generation circuit 10 in the first embodiment. As shown in FIG. 2, the signal generation circuit 10 includes a local oscillator 20, a pulse generator 21, an intra-pulse modulator 22, and an output unit 23. The local oscillator 20 generates a local oscillation signal L₀(t) in an operating frequency band, and outputs the local oscillation signal L₀(t) to the pulse generator 21 and the receiving circuit 13.

Specifically, the local oscillator 20 can generate a local oscillation signal L₀(t) having a constant transmission frequency f₀ within a certain observation period (period from time t=0 to time t=T_{obs}) as shown by the following equation (1).

L₀(t)=A_{L} exp(j(2πf₀t+ϕ₀))

(0≤t<T_{obs)} (1)

Here, t is time, A_{L} is amplitude of the local oscillation signal L₀(t), φ₀ is an initial phase of the local oscillation signal L₀(t), T_{obs} is an upper limit of the observation period, and j is an imaginary unit.

The PRI control unit 14 shown in FIG. 1 supplies a pulse width T₀ and a series of pulse repetition intervals Tₚᵣᵢ(0) to Tₚᵣᵢ(H−1) to the pulse generator 21. The pulse generator 21 shown in FIG. 2 can modulate the local oscillation signal L₀(t) to continuously generate a plurality of pulse signals on the basis of the pulse width T₀ and the pulse repetition interval Tₚᵣᵢ(h).

For example, the PRI control unit 14 can calculate the pulse repetition interval Tₚᵣᵢ(h) as shown by an equation (2) for h=0,1, . . . , H−1, on the basis of a predetermined reference interval T_{pri,0} and a change amount ΔTₚᵣᵢ(h) regarding the hit number h.

Tₚᵣᵢ(h)=T_{pri,0}+ΔTₚᵣᵢ(h)

(h=0,1, . . . , H−1) (2)

More specifically, the PRI control unit 14 sets a plurality of pairs of a pulse repetition interval longer than the reference interval T_{pri,0} and a pulse repetition interval shorter than the reference interval T_{pri,0}. By setting such a pulse repetition interval, it is possible to suppress radio wave interference with other radar systems. For example, the PRI control unit 14 can set a plurality of pairs of pulse repetition intervals each having symmetrical values about the reference interval T_{pri,0}, and match an average value of the pulse repetition intervals constituting each pair with the reference interval T_{pri,0}. The following equation (3) is an equation showing a setting example of the pulse repetition interval Tₚᵣᵢ(h).

$$\begin{matrix}{T}_{pri} ( h ) = \{ \begin{matrix}( 1 + {K}_{pri} ( h ) ) {T}_{pri , 0} , & h = 2 k \\ ( 1 - {K}_{pri} ( h ) ) {T}_{pri , 0} , & h = 2 k + 1\end{matrix} & ( 3 ) \\ ( h = 0 , 1 , … , H - 1 ) & \end{matrix}$$

In the equation (3), k indicates an integer equal to or more than 0, and Kₚᵣᵢ(h) is a coefficient for controlling the pulse repetition interval (PRI) regarding the hit number h (hereinafter sometimes referred to as “PRI coefficient”). According to the equation (3), it is set so that when the hit number h is an even number (h=2k), the pulse repetition interval Tₚᵣᵢ(h) takes a value of (1+Kₚᵣᵢ(h))T_{pri,0}, and when the hit number h is an odd number (h=2k+1), the pulse repetition interval Tₚᵣᵢ(h) takes a value of (1-Kₚᵣᵢ(h))T_{pri,0}. The PRI coefficient Kₚᵣᵢ(h) may be set to a constant value regardless of the value of the hit number h, or may be set to an individual value for each hit number h.

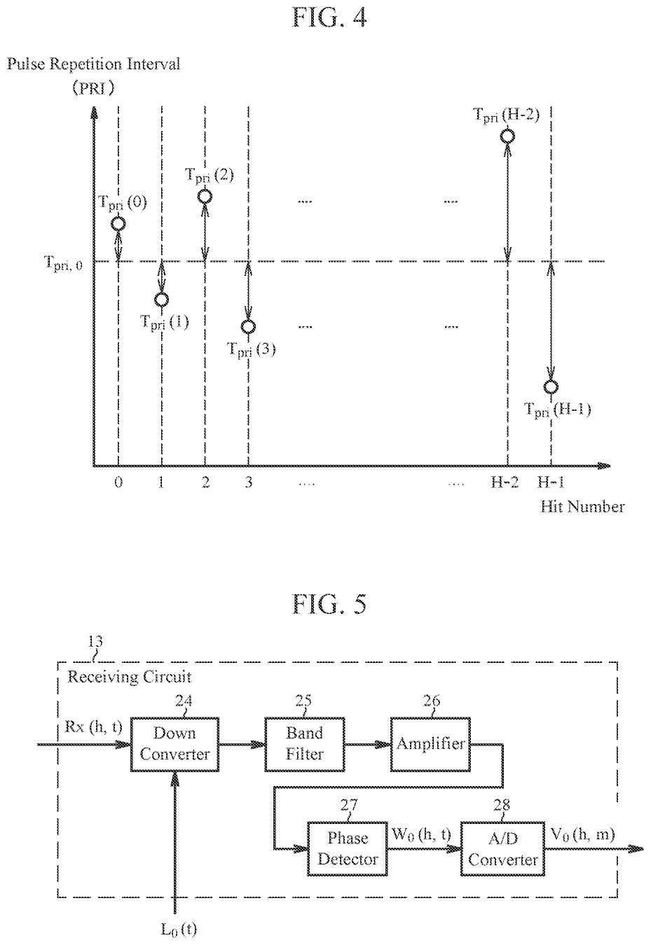

FIGS. 3 and 4 are graphs showing setting examples of the pulse repetition interval Tₚᵣᵢ(h). In the graphs of FIGS. 3 and 4, a horizontal axis represents the hit number h, a vertical axis represents the pulse repetition interval Tₚᵣᵢ(h), and a circle represents a value of the pulse repetition interval Tₚᵣᵢ(h). In the setting example of FIG. 3, the PRI coefficient Kₚᵣᵢ(h) in the equation (3) is set to a constant value regardless of the value of the hit number h. At this time, the change amount ΔTₚᵣᵢ(h) in the equation (2) is constant. On the other hand, in the setting example of FIG. 4, the PRI coefficient Kₚᵣᵢ(h) in the equation (3) is set to a different value for each hit number h, and as the value of the hit number h is higher, the change amount ΔTₚᵣᵢ(h)(=Kₚᵣᵢ(h)×T_{pri,0}) is set to a higher value. From the viewpoint of preventing interference between received signals (for example, received analog signals), the pulse repetition interval Tₚᵣᵢ(h) shown in FIG. 4 is preferable to the pulse repetition interval Tₚᵣᵢ(h) shown in FIG. 3.

The PRI control unit 14 in the present embodiment is a component different from the signal generation circuit 10, but is not limited thereto. The PRI control unit 14 may be incorporated in the signal generation circuit 10 or the radar signal processing circuit 30.

Next, the pulse generator 21 shown in FIG. 2 can modulate the local oscillation signal L₀(t) to generate a plurality of pulse signals Lₚₗₛ(h,t)(h=0,1, . . . ,H−1) on the basis of the pulse width T₀ and the series of pulse repetition intervals Tₚᵣᵢ(h)(h=0,1, . . . , H−1) set by the PRI control unit 14.

Specifically, the pulse generator 21 can modulate the local oscillation signal L₀(t) to generate the plurality of pulse signals Lₚₗₛ(h,t)(h=0,1, . . . , H−1) shown in the following equation (4) on the basis of the pulse width T₀ and the series of pulse repetition intervals Tₚᵣᵢ(h)(h=0,1, . . . , H−1).

$$\begin{matrix}{L}_{pls} ( h , t ) = \{ \begin{matrix}{A}_{L} exp ( j ( 2 π {f}_{0} t + {φ}_{0} ) ) , & t ∈ Ω [ h ] \\ 0 , & t ∉ Ω [ h ]\end{matrix} & ( 4 ) \\ ( h = 0 , 1 , … , H - 1 ) & \end{matrix}$$

In the equation (4), Ω[h] is a set of time t that satisfies the following equation (5) (where Tₚᵣᵢ(−1)=0).

$${\sum }_{n = - 1}^{h - 1} {T}_{pri} ( n ) \leq t < {\sum }_{n = - 1}^{h - 1} {T}_{pri} ( n ) + {T}_{0} \qquad ( 5 )$$

Note that the PRI control unit 14 in the present embodiment is a component different from the signal generation circuit 10, but is not limited to this. The PRI control unit 14 may be incorporated in the signal generation circuit 10 or the radar signal processing circuit 30.

Next, the intra-pulse modulator 22 performs intra-pulse modulation on each of the plurality of pulse signals to generate a plurality of intra-pulse modulation signals as the transmission pulse signals Tx(h,t). The output unit 23 outputs these transmission pulse signals Tx(h,t) to the transmission and reception unit 11. At this time, the output unit 23 may perform processing such as amplification on the transmission pulse signals Tx(h,t). Specifically, the intra-pulse modulator 22 first generates a modulation control signal L_{chp}(h,t) for frequency-modulating the pulse signal Lₚₗₛ(h,t) using a modulation bandwidth B₀ according to the following equation (6).

$$\begin{matrix}{L}_{chp} ( h , t ) = \{ \begin{matrix}{A}_{L } exp ( j 2 π ( {f}_{0} t + \frac{{B}_{0}}{2 {T}_{0}} {t}^{2} ) ) , & t ∈ Ω [ h ] \\ 0 , & t ∉ Ω [ h ]\end{matrix} & ( 6 ) \\ ( h = 0 , 1 , … , H - 1 ) & \end{matrix}$$

Furthermore, as shown in the following equation (7), the intra-pulse modulator 22 can generate an intra-pulse modulation signal frequency-modulated using the modulation control signal L_{chp}(h,t), that is, the transmission pulse signal Tx(h,t).

$$\begin{matrix}Tx ( h , t ) = {L}_{pls} ( h , t ) {L}_{chp} ( h , t ) = \{ \begin{matrix}{A}_{L} exp ( j \{ 2 π [ {f}_{0} t + \frac{{B}_{0}}{2 {T}_{0}} {t}^{2} ] + {φ}_{0} \} ) , & t ∈ Ω [ h ] \\ 0 , & t ∉ Ω [ h ]\end{matrix} & ( 7 ) \\ ( h = 0 , 1 , … , H - 1 ) & □\end{matrix}$$

The antenna 12 can radiate the plurality of transmission pulse signals Tx(h,t) to the external space as the transmission waves Tw, and then receive the reflected waves Rw returned from a target Tgt in the external space. The transmission and reception unit 11 can output the reflected wave signal Rx(h,t) as shown in the following equation (8).

$$\begin{matrix}Rx ( h , t ) = \{ \begin{matrix}\begin{matrix}{A}_{R} exp ( j \{ 2 π [ {f}_{0} ( τ - \frac{2 ( {R}_{0} - vt )}{c} ) + \\ \frac{{B}_{0}}{2 {T}_{0}} {( τ - \frac{2 ( {R}_{0} - vt )}{c} )}^{2} ] + {φ}_{0} \} ) ,\end{matrix} & t ∈ Λ [ h ] \\ 0 , & t ∉ Λ [ h ]\end{matrix} & ( 8 ) \\ ( h = 0 , 1 , … , H - 1 ) & \end{matrix}$$

In the equation (8), AR is amplitude of the reflected wave signal Rx(h,t) reflected on the target Tgt, R₀ is an initial target relative distance, v is target relative velocity, τ is time within one pulse, and c is light velocity. Further, Λ[h] is a set of time t satisfying the following equation (9).

$${\sum }_{n = - 1}^{h - 1} {T}_{pri} ( n ) + \frac{2 {R}_{0}}{c} \leq t < {\sum }_{n = - 1}^{h - 1} {T}_{pri} ( n ) + \frac{2 {R}_{0}}{c} + {T}_{0} \qquad ( 9 )$$

Next, the configuration of the receiving circuit 13 will be described. FIG. 5 is a block diagram schematically showing a configuration example of the receiving circuit 13. As shown in FIG. 5, the receiving circuit 13 includes a down converter (mixer) 24, a band filter 25, an amplifier 26, a phase detector 27, and an A/D converter 28.

The down converter 24 shown in FIG. 5 converts the reflected wave signal Rx(h,t) into an analog signal in a lower frequency band (for example, an intermediate frequency band). The band filter 25 filters the analog signal and outputs a filter signal. The amplifier 26 amplifies the filter signal and outputs an amplified signal. Then, the phase detector 27 performs phase detection of the amplified signal and generates a detection signal composed of an in-phase component and an orthogonal component as the received analog signal W₀(h,t). The following equation (10) is an equation representing the received analog signal W₀(h,t).

$$\begin{matrix}{W}_{0} ( h , t ) = Rx ( h , t ) {L}_{0}^{*} ( t ) = \{ \begin{matrix}{A}_{V} exp ( j 2 π [ - {f}_{0} \frac{2 ( {R}_{0} - vt )}{c} + \frac{{B}_{0}}{2 {T}_{0}} {( τ - \frac{2 ( {R}_{0} - vt )}{c} )}^{2} ] ) , & t ∈ Λ [ h ] \\ 0 , & t ∉ Λ [ h ]\end{matrix} & ( 10 ) \\ ( h = 0 , 1 , … , H - 1 ) & \end{matrix}$$

Here, A_{V} indicates amplitude of the received analog signal W₀(h,t), and an upper right superscript “*” indicates a complex conjugate. A local oscillation signal L₀*(t) is a complex conjugate of the local oscillation signal L₀(t).

The A/D converter 28 can generate the received digital signal (received video signal) V₀(h,m) as shown in the following equation (11) by sampling the received analog signal W₀(h,t) at a predetermined sampling interval Δt.

$$\begin{matrix}{V}_{0} ( h , m ) = \{ \begin{matrix}\begin{matrix}A exp ( - j 2 π {f}_{0} \cdot 2 ( {R}_{0} - v ( {\sum }_{n = - 1}^{h - 1} {T}_{pri} ( n ) + m Δ t ) ) / c ) \\ exp ( j 2 π \frac{{B}_{0}}{2 {T}_{0}} {( m Δ t - 2 ( {R}_{0} - v ( {\sum }_{n = - 1}^{h - 1} {T}_{pri} ( n ) + m Δ t ) ) / c )}^{2} ) ,\end{matrix} & m ∈ Ψ [ h ] \\ 0 , & m ∉ Ψ [ h ]\end{matrix} & ( 11 ) \\ ( m = 0 , 1 , … , M ( h ) - 1 ) & \\ ( h = 0 , 1 , … , H - 1 ) & \end{matrix}$$

In the equation (11), m is an integer in the range of 0 to M(h)−1 representing a sampling number, and Ψ[h] is a set of sampling numbers m that satisfy a conditional expression of the following equation (12).

$${\sum }_{n = - 1}^{h - 1} {T}_{pri} ( n ) + \frac{2 {R}_{0}}{c} \leq m Δ t < {\sum }_{n = - 1}^{h - 1} {T}_{pri} ( n ) + \frac{2 {R}_{0}}{c} + {T}_{0} \qquad ( 12 )$$

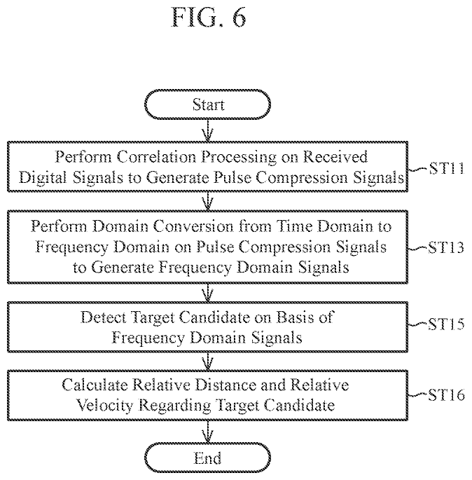

The radar signal processing circuit 30 can perform digital signal processing on the received digital signal V₀(h,m) to detect a target candidate. Hereinafter, configuration and operation of the radar signal processing circuit 30 will be described by referring to FIGS. 1 and 6. FIG. 6 is a flowchart schematically showing an operation procedure of the radar signal processing circuit 30 in the first embodiment.

As shown in FIG. 1, the radar signal processing circuit 30 includes a signal conversion unit 40 and a target detection unit 50. The signal conversion unit 40 includes a correlation processing unit 42 that generates a pulse compression signal F_{V·Ex}(h,m) by performing correlation processing using a reference signal on the received digital signal V₀(h,m) and a domain conversion unit 44 that generates a plurality of frequency domain signals f_{d}(h_{fft},m)(h_{fft}=0 to H−1) by performing, on a plurality of the pulse compression signals F_{V·Ex}(h,m)(h=0 to H−1), a discrete Fourier transform in a pulse hit direction on the basis of a predetermined algorithm. Further, the target detection unit 50 includes a target candidate detection unit 51 that detects a target candidate on the basis of the frequency domain signal f_{d}(h_{fft},m) and a target candidate information calculating unit 52 that calculates target information related to the detected target candidate.

First, when received digital signals V₀(h,m) are input, the correlation processing unit 42 generates pulse compression signals F_{V·Ex}(h,m) by performing correlation processing using a reference signal Ex(m) on the received digital signals V₀(h,m) (step ST11). Specifically, the correlation processing unit 42 can generate the pulse compression signals F_{V·Ex}(h,m) by performing a correlation calculation between the reference signal Ex(m) and the received digital signals V₀(h,m). As the reference signal Ex(m), a reference signal having a modulation component B₀/(2T₀) of the modulation control signal L_{chp}(h,t) can be used as shown in the following equation (13).

$$Ex ( m ) = \{ \begin{matrix}{A}_{E} exp ( j 2 π \frac{{B}_{0}}{2 {T}_{0}} {m}^{2} Δ {t}^{2} ) , & Δ t ∈ Φ [ m ] \\ 0 , & Δ t ∉ Φ [ m ]\end{matrix} \qquad ( 13 )$$

In the equation (13), A_{E} is amplitude of the reference signal Ex(m), and Φ[m] is a set of Δt satisfying a condition of the following equation (14).

0≤mΔt≤T₀ (14)

For example, the correlation processing unit 42 may perform the correlation calculation by performing convolution operation as shown in the following equation (15).

$$\begin{matrix}{F}_{V \cdot Ex} ( h , m ) = {\sum }_{p = - {M}_{p} / 2}^{{M}_{p} / 2} {V}_{0} ( h , m + p ) {Ex}^{*} ( p ) & ( 15 ) \\ ( m = 0 , 1 , … , M ( h ) - 1 ) & \\ ( h = 0 , 1 , … , H - 1 ) & \end{matrix}$$

Here, Mₚ is a sampling point in the pulse. Note that, instead of the correlation calculation represented by the equation (15), a correlation calculation based on a known frequency domain convolution calculation may be performed.

Next, the domain conversion unit 44 performs a discrete Fourier transform based on a predetermined algorithm on the pulse compression signals F_{V·Ex}(h,m) to generate frequency domain signals f_{d}(h_{fft},m) (step ST13). The discrete Fourier transform is expressed by the following equation (16).

$$\begin{matrix}{f}_{d} ( {h}_{fft} , m ) = {\sum }_{h = 0}^{H - 1} {F}_{V \cdot Ex} ( h , m ) exp ( - j 2 π \frac{h}{H} {h}_{fft} ) & ( 16 ) \\ ( {h}_{fft} = 0 , 1 , … , H - 1 ) & \\ ( m = 0 , 1 , … , M ( h ) - 1 ) & \end{matrix}$$

Here, h_{fft} is a sampling number in the frequency domain, and H is a discrete Fourier transform point.

By deforming the equation (16) using the equations (11) to (15), the following equation (17) can be obtained.

$${f}_{d} ( {h}_{fft} , m ) = {\sum }_{h = 0}^{H - 1} A exp ( - j 2 π {f}_{0} \cdot 2 ( {R}_{0} - v ( {\sum }_{n = - 1}^{h - 1} {T}_{pri} ( n ) + m Δ t ) ) / c ) exp ( - j 2 π \frac{h}{H} {h}_{fft} ) \qquad ( 17 )$$

Here, A is amplitude of the frequency domain signal f_{d}(h_{fft},m).

By rearranging the equation (17), the following equation (18) can be obtained.

$$\begin{matrix}{f}_{d} ( {h}_{fft} , m ) = exp ( - j 2 π {f}_{0} \frac{2 {R}_{0}}{c} ) exp ( j 2 π {f}_{0} \frac{2 vm Δ t}{c} ) & ( 18 ) \\ {\sum }_{h = 0}^{H - 1} A exp ( j 2 π ( {f}_{0} \cdot 2 v {\sum }_{n = - 1}^{h - 1} {T}_{pri} ( n ) / c - \frac{h}{H} {h}_{fft} ) ) & \end{matrix}$$

A right side of the equation (18) consists of a product of three terms. When magnitude of a value of a third term of the product on the right side is maximized, high integration efficiency can be obtained in the discrete Fourier transform. A condition that the magnitude of the value of the third term is almost maximized is as shown in the following equation (19).

$${f}_{0} \cdot 2 v {\sum }_{n = - 1}^{h - 1} {T}_{pri} ( n ) / c - \frac{h}{H} {h}_{fft} ≅ 0 \qquad ( 19 )$$

When an average value of pulse repetition intervals Tₚᵣᵢ(h) on a left side of the equation (19) substantially matches the reference interval T_{pri,0}, the equation (19) is expressed by the following equation (20).

$${f}_{0} \frac{2 {vT}_{pri , 0}}{c} - \frac{{h}_{fft}}{H} ≅ 0 \qquad ( 20 )$$

One condition that the average value of the pulse repetition intervals Tₚᵣᵢ(h) substantially matches the reference interval T_{pri,0} is, as described above, to set a plurality of pairs of pulse repetition intervals each having symmetrical values about the reference interval T_{pri,0}. The average value of the pulse repetition intervals forming each pair of the plurality of pairs matches the reference interval T_{pri,0}. As a more specific example, when the equation (3) is used, the average value of the pulse repetition intervals Tₚᵣᵢ(h) can be made to substantially match the reference interval T_{pri,0}.

Assuming that the sampling number h_{fft} satisfying a condition of the equation (20) is expressed as h_{fft,peak}, the sampling number h_{fft,peak} is expressed as shown in the following equation (21).

$${h}_{fft , peak} ≅ {f}_{0} \frac{2 {vT}_{pri , 0}}{c} H \qquad ( 21 )$$

Thus, high integration efficiency can be obtained for the sampling number h_{fft,peak} in the frequency domain. At this time, a frequency range based on the reference interval T_{pri,0} can be calculated on the basis of a velocity value v_{amb,0} in the following equation (22).

$${v}_{amb , 0} = \frac{c}{2 {f}_{0} {T}_{pri , 0}} \qquad ( 22 )$$

Even if the pulse repetition intervals forming each pair do not have completely symmetrical values, when the plurality of pairs of the pulse repetition interval longer than the reference interval T_{pri,0} and the pulse repetition interval shorter than the reference interval T_{pri,0} is set so as to satisfy the condition that the average value of the pulse repetition intervals Tₚᵣᵢ(h) substantially matches the reference interval T_{pri,0} as shown in the following equation (23), it is possible to perform coherent integration based on the discrete Fourier transform with high efficiency.

$${\sum }_{n = 0}^{h - 1} \frac{{T}_{pri} ( n )}{h} ≅ {T}_{pri , 0} \qquad ( 23 )$$

After the frequency domain signals f_{d}(h_{fft},m) are generated (step ST13 in FIG. 6), the target candidate detection unit 51 detects a target candidate on the basis of signal strength of the frequency domain signals f_{d}(h_{fft},m) (step ST15). Specifically, for example, the target candidate detection unit 51 may detect the target candidate by using known CA-CFAR (Cell Average-Constant False Alarm Rate) processing. For example, in the CA-CFAR processing, since the maximum detection probability can be obtained so that a false alarm probability P_{fa} becomes a constant value, false detection can be controlled, and the target candidate can be detected on the basis of the signal strength of the frequency domain signals f_{d}(h_{fft},m) without detecting noise as much as possible.

The target candidate detection unit 51 can output, to the target candidate information calculating unit 52, a target candidate number ntg assigned to the detected single or multiple target candidates, a sampling number m=m_{ntg} corresponding to the target candidate number ntg, and a sampling number h_{fft}=h_{fft,ntg} of the frequency domain corresponding to the target candidate number ntg. For convenience of explanation, the target candidate number ntg takes an integer in the range of 1 to N_{tg}.

Next, the target candidate information calculating unit 52 calculates a relative distance and relative velocity regarding the target candidate, and outputs data indicating the relative distance and the relative velocity to the display 60 (step ST16 in FIG. 6). Specifically, for example, the target candidate information calculating unit 52 can calculate a relative distance R_{0,ntg} of an ntg-th target candidate on the basis of the target candidate number ntg and the sampling number m_{ntg} according to the following equation (24).

$$\begin{matrix}{R}_{0 , ntg} = \frac{{m}_{ntg} Δ t}{c} & ( 24 ) \\ ( ntg = 1 , … , {N}_{tg} ) & \end{matrix}$$

Further, the target candidate information calculating unit 52 can calculate relative velocity V_{0,ntg} of the ntg-th target candidate according to the following equation (25).

V_{0,ntg}=h_{fft,ntg}Δv_{fft}

(n_{tgt}=1, . . . , N_{tgt}) (25)

In the equation (25), Δv_{fft} is a sampling interval of the relative velocity as shown in the following equation (26).

$$Δ {v}_{fft} = \frac{c}{2 {f}_{0} {T}_{pri , 0} H} {h}_{fft , ntg} \qquad ( 26 )$$

The target candidate information calculating unit 52 can output a combination of the target candidate number ntg, the relative distance R_{0,ntg}, and the relative velocity V_{0,ntg} to the display 60 as the target information. The display 60 can display the target information on a screen.

According to the first embodiment, the signal conversion unit 40 performs domain conversion processing using the discrete Fourier transform without using the relative velocity of the target candidate detected by the target detection unit 50. Even in this case, the PRI control unit 14 sets the plurality of pairs of the pulse repetition interval longer than the reference interval T_{pri,0} and the pulse repetition interval shorter than the reference interval T_{pri,0}, so that the signal strength of the frequency domain signal f_{d}(h_{fft},m) can be increased, and integration loss when the domain conversion processing is performed can be suppressed. Thus, it is possible to improve target detection performance.

In particular, as illustrated in FIGS. 3 and 4, when the plurality of pairs of the even-numbered and odd-numbered pulse repetition intervals each having symmetrical values about the reference interval T_{pri,0} is set and the average value of the pulse repetition intervals constituting each pair matches the reference interval T_{pri,0}, the integration loss can be suppressed.

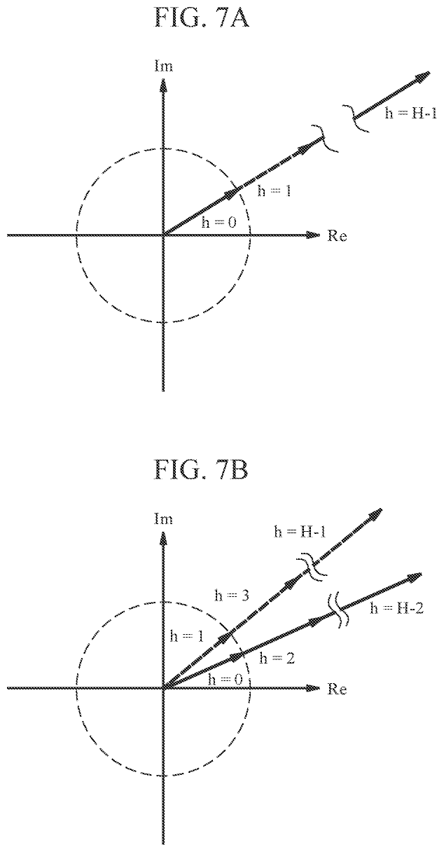

FIG. 7A is a diagram schematically showing an example of a phase state of pulse compression signals F_{V·Ex}(h,m)(h=0 to H−1) when all the pulse repetition intervals Tₚᵣᵢ(0) to Tₚᵣᵢ(H−1) are set to the same value. On the other hand, FIG. 7B is a diagram schematically showing an example of a phase state of pulse compression signals F_{V·Ex}(h,m)(h=0 to H−1) when the pulse repetition intervals Tₚᵣᵢ(0) to Tₚᵣᵢ(H−1) are set in accordance with the equation (3) according to the present embodiment. In graphs of FIGS. 7A and 7B, a horizontal axis represents a real part Re of the pulse compression signal F_{V·Ex}(h,m), and a vertical axis represents an imaginary part Im of the pulse compression signal F_{V·Ex}(h,m). As illustrated in FIG. 7B, since phases of the pulse compression signals F_{V·Ex}(h,m) are almost coherent in one or both of a case where the hit number h is even and a case where the hit number h is odd, it is possible to suppress a decrease in integration efficiency.

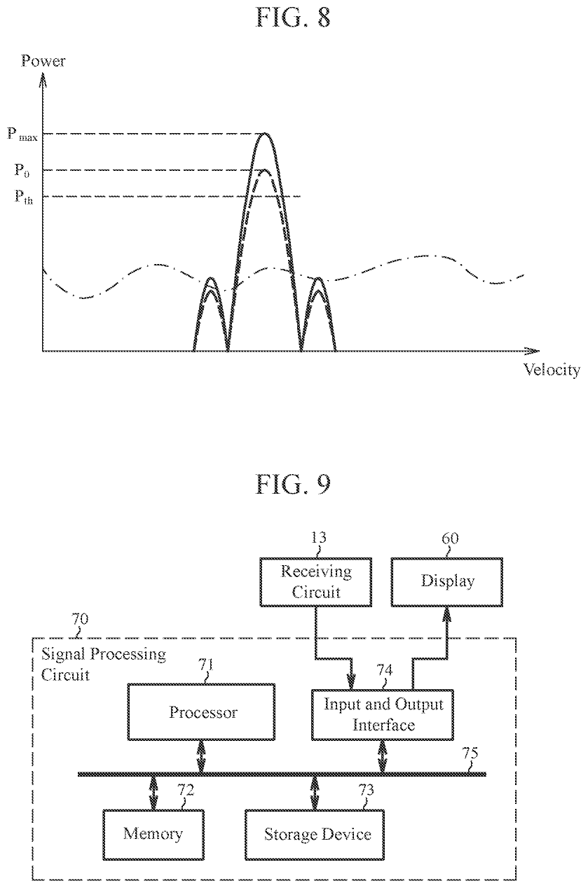

FIG. 8 is a graph schematically showing an example of spectra of three types of frequency domain signals. In the graph of FIG. 8, a horizontal axis represents velocity corresponding to frequency, and a vertical axis represents power. In FIG. 8, a solid line represents a spectrum of a frequency domain signal f_{d}(h_{fft},m) obtained when it is assumed that all the pulse repetition intervals Tₚᵣᵢ(0) to Tₚᵣᵢ(H−1) are set to the same value, and a broken line represents a spectrum of a frequency domain signal f_{d}(h_{fft},m) obtained when the pulse repetition intervals Tₚᵣᵢ(0) to Tₚᵣᵢ(H−1) are set in accordance with the equation (3) according to the present embodiment. Further, an alternate long and short dash line represents a spectrum of a frequency domain signal f_{d}(h_{fft},m) when it is assumed that the pulse repetition intervals Tₚᵣᵢ(0) to Tₚᵣᵢ(H−1) are randomly set.

When it is assumed that all the pulse repetition intervals are set to the same value, complete coherent integration is performed to obtain power Pₘₐₓ, as shown in FIG. 8. When it is assumed that the pulse repetition intervals Tₚᵣᵢ(0) to Tₚᵣᵢ(H−1) are randomly set, power P_{rand} diffuses. On the other hand, when the pulse repetition intervals Tₚᵣᵢ(0) to Tₚᵣᵢ(H−1) are set in accordance with the equation (3), the power Pₘₐₓ cannot be obtained, but desired power P₀ equal to or larger than threshold power Pₜₕ can be ensured.

In this regard, the signal conversion unit 40 can set the change amount ΔTₚᵣᵢ(h) in the equation (2) to a value that satisfies the following equations (27), (28), and (29) so that the PRI control unit 14 ensures the desired power P₀ equal to or larger than the threshold power Pₜₕ and a desired signal-to-noise power ratio SNR₀.

$$\begin{matrix}Δ {T}_{pri} ( h ) = {\sum }_{n = 0}^{h - 1} {T}_{pri} ( n ) - ( h - 1 ) {T}_{pri , 0} < Δ {D}_{pri} & ( 27 ) \\ ( h = 1 , … , H - 1 ) & \\ {P}_{rand} < {P}_{th} \leq {P}_{0} < {P}_{max} & ( 28 ) \\ {SNR}_{rnd} < {SNR}_{th} \leq {SNR}_{0} < {SNR}_{max} & ( 29 )\end{matrix}$$

In the equation (27), ΔDₚᵣᵢ is an upper limit of the change amount ΔTₚᵣᵢ(h). In the equation (29), SNRₘₐₓ is a signal-to-noise power ratio obtained with the power Pₘₐₓ in FIG. 8, SNR_{rnd} is a signal-to-noise power ratio obtained with the power P_{rand} in FIG. 8, and SNRₜₕ is a signal-to-noise power ratio obtained with the threshold power Pₜₕ in FIG. 8.

As described above, in the first embodiment, the integration loss during execution of the domain conversion processing using the discrete Fourier transform can be suppressed without requiring the value of the relative velocity of the target candidate detected by the target detection unit 50. Thus, it is possible to improve target detection performance. Therefore, it is possible to provide the radar apparatus 1 that achieves the desired integration efficiency and the high SNR and has the improved target detection performance.

Note that a hardware configuration of the PRI control unit 14 and the radar signal processing circuit 30 may be implemented by an LSI (Large Scale Integrated circuit) such as an ASIC (Application Specific Integrated Circuit) or an FPGA (Field-Programmable Gate Array).

FIG. 9 is a block diagram showing a hardware configuration example that implements functions of the PRI control unit 14 and the radar signal processing circuit 30. A signal processing circuit 70 shown in FIG. 9 includes a processor 71 composed of an LSI, an input and output interface 74, a memory 72, a storage device 73, and a signal path 75. The signal path 75 is a bus for connecting the processor 71, the input and output interface 74, the memory 72, and the storage device 73 to each other. The processor 71 is connected to the display 60 and the receiving circuit 13 via the input and output interface 74.

The memory 72 includes, for example, a program memory for storing various program codes to be executed by the processor 71 to implement the functions of the PRI control unit 14 and the radar signal processing circuit 30, a work memory used when the processor 71 executes digital signal processing, and a temporary storage memory in which data used in the digital signal processing is expanded. As the memory 72, a plurality of semiconductor memories such as an ROM (Read Only Memory) and an SDRAM (Synchronous Dynamic Random Access Memory) may be used.

The processor 71 can access the storage device 73. The storage device 73 is used to store various data such as setting data and signal data for the processor 71. As the storage device 73, for example, a volatile memory such as the SDRAM, an HDD (Hard Disk Drive), or an SSD (Solid State Drive) can be used. It should be noted that this storage device 73 can also store data to be stored in the memory 72.

In the example of FIG. 9, the signal processing circuit 70 is implemented by using the single processor 71, but is not limited thereto. The functions of the PRI control unit 14 and the radar signal processing circuit 30 may be implemented by using a plurality of processors that operate in cooperation with each other. Furthermore, any of the functions of the PRI control unit 14 and the radar signal processing circuit 30 may be implemented by dedicated hardware.

### Second Embodiment

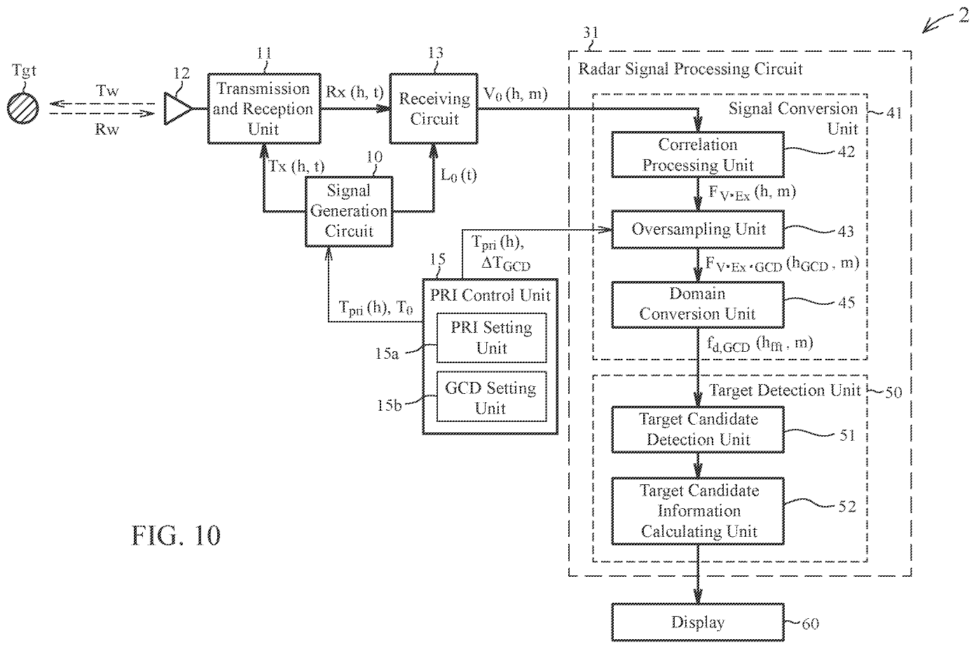

FIG. 10 is a block diagram schematically showing a configuration of a radar apparatus 2 according to a second embodiment of the present invention. As shown in FIG. 10, the radar apparatus 2 includes a signal generation circuit 10, a transmission and reception unit 11, a receiving circuit 13, a radar signal processing circuit 31, and a display 60. The configuration of the radar apparatus 2 in the present embodiment is the same as the configuration of the radar apparatus 1 in the first embodiment, except that the radar signal processing circuit 31 in FIG. 10 is provided instead of the radar signal processing circuit 30 in the first embodiment, and the PRI control unit 15 in FIG. 10 is provided instead of the PRI control unit 14 in the first embodiment.

The PRI control unit 15 in the present embodiment has a PRI setting unit 15a and a GCD setting unit 15b. Similarly to the PRI control unit 14 in the first embodiment, the PRI setting unit 15a supplies a pulse width To and a series of pulse repetition intervals Tₚᵣᵢ(0) to Tₚᵣᵢ(H−1) to the signal generation circuit 10. The PRI setting unit 15a sets a plurality of pairs of a pulse repetition interval longer than a reference interval T_{pri,0} and a pulse repetition interval shorter than the reference interval T_{pri,0}, and can supply the plurality of pairs of pulse repetition intervals to the signal generation circuit 10 as the series of pulse repetition intervals Tₚᵣᵢ(0) to Tₚᵣᵢ(H−1).

The GCD setting unit 15b sets a greatest common divisor ΔT_{GCD} of the series of pulse repetition intervals Tₚᵣᵢ(0) to Tₚᵣᵢ(H−1) set by the PRI setting unit 15a, and supplies the greatest common divisor ΔT_{GCD} to the signal conversion unit 41. The greatest common divisor ΔT_{GCD} is expressed by the following equation (30).

ΔT_{GCD}=GCD(Tₚᵣᵢ(0), . . . , Tₚᵣᵢ(H−1)) (30)

In the equation (30), GCD( ) is an operator that gives the greatest common divisor of H pulse repetition intervals Tₚᵣᵢ(0) to Tₚᵣᵢ(H−1). The GCD setting unit 15b may calculate a set value of the greatest common divisor ΔT_{GCD}, or may use a data value stored in advance in the memory as the set value of the greatest common divisor ΔT_{GCD}. The value of the greatest common divisor ΔT_{GCD} may be expressed as an integer or a decimal number. Further, the value of the greatest common divisor ΔT_{GCD} may be calculated with accuracy that can obtain a desired suppression amount of integration loss and a desired signal-to-noise ratio.

Similarly to the signal conversion unit 40 in the first embodiment, the signal conversion unit 41 in the present embodiment includes a correlation processing unit 42 that generates a pulse compression signal F_{V·Ex}(h,m) by performing correlation processing using a reference signal on a received digital signal V₀(h,m).

The signal conversion unit 41 in the present embodiment further includes an oversampling unit 43 and a domain conversion unit 45. The oversampling unit 43 has a function of converting pulse compression signals F_{V·Ex}(h,m)(h=0 to H−1) having H data points that are temporally unequally spaced regarding a hit number h into oversample signals F_{V·Ex·GCD}(h_{GCD},m)(h_{GCD}=0 to Q−1) having Q data points that are temporally equally spaced. A sampling point Q is, for example, an integer given by the following equation (31).

$$Q = {\sum }_{n = 0}^{H - 1} {T}_{pri} ( n ) / Δ {T}_{GCD} \qquad ( 31 )$$

The domain conversion unit 45 generates frequency domain signals f_{d,GCD}(h_{fft},m)(h_{fft}=0 to Q−1) having Q data points by performing a discrete Fourier transform in a pulse hit direction on the oversample signals F_{V·Ex·GCD}(h_{GCD},m)(h_{GCD}=0 to Q−1) having the Q data points.

Since the PRI control unit 15 sets a pulse repetition interval Tₚᵣᵢ(h) that makes pulse wave transmission intervals unequal, H data points of the received digital signals V₀(h,m)(h=0 to H−1) are data points that are temporally unequally spaced in the pulse hit direction. In the first embodiment, H data points of the pulse compression signals F_{V·Ex}(h,m) generated from the received digital signals V₀(h,m) are also temporally unequally spaced data points in the pulse hit direction. Since the domain conversion unit 44 in the first embodiment performs the discrete Fourier transform on the unequally spaced data points, there is a case where sufficient integration efficiency or sufficient calculation accuracy cannot be obtained.

Therefore, the oversampling unit 43 in the second embodiment uses the greatest common divisor ΔT_{GCD} and converts the pulse compression signals F_{V·Ex}(h,m)(h=0 to H−1) having the H data points that are temporally unequally spaced in the pulse hit direction into the oversample signals F_{V·Ex·GCD}(h_{GCD},m)(h_{GCD}=0 to Q−1) having the Q data points that are temporally equally spaced in the pulse hit direction.

As a result, the domain conversion unit 45 in the present embodiment can perform an accurate discrete Fourier transform on the oversample signal F_{V·Ex·GCD}(h_{GCD},m). In particular, when the discrete Fourier transform is performed on the basis of an algorithm of a Fast Fourier Transform (FFT), data points that are temporally equally spaced are required. In the present embodiment, the fast Fourier transform (FFT) can improve the integration efficiency with a small amount of calculation.

Specifically, the oversampling unit 43 performs oversampling at a ratio of Tₚᵣᵢ(h)/ΔT_{GCD} using the greatest common divisor ΔT_{GCD} given by the above equation (30) for each pulse repetition interval Tₚᵣᵢ(h).

Now, for the same sampling number m, it is assumed that a pulse compression signal F_{V·Ex}(0,m) when the hit number h is zero matches an oversample signal F_{V·Ex·GCD}(0,m) when a sampling number h_{GCD} is zero. For the non-zero hit number h, consider a case where the sampling number h_{GCD} is limited to a range shown by the following equation (32) (where, Tₚᵣᵢ(−1)=0).

$$\begin{matrix}{\sum }_{n = - 1}^{( h - 1 ) - 1} {T}_{pri} ( n ) / Δ {T}_{GCD} < {h}_{GCD} \leq {\sum }_{n = - 1}^{h - 1} {T}_{pri} ( n ) / Δ {T}_{GCD} & ( 32 ) \\ ( h = 1 , … , H - 1 ) & \end{matrix}$$

Under a condition of the equation (32), the oversampling unit 43 can generate the oversample signal F_{V·Ex·GCD}(h_{GCD},m) for the same sampling number m in accordance with the following equation (33).

$$\begin{matrix}{F}_{V \cdot Ex \cdot GCD} ( {h}_{GCD} , m ) = \{ \begin{matrix}{F}_{V \cdot Ex} ( h , m ) , & mod ( {h}_{GCD} , {\sum }_{n = - 1}^{h - 1} {T}_{pri} ( n ) / Δ {T}_{GCD} ) = 0 \\ 0 , & mod ( {h}_{GCD} , {\sum }_{n = - 1}^{h - 1} {T}_{pri} ( n ) / Δ {T}_{GCD} ) \neq 0\end{matrix} & ( 33 ) \\ ( h = 1 , … , H - 1 ) & \\ ( m = 0 , 1 , … , M ( h ) - 1 ) & \end{matrix}$$

Here, mod(x,y) is a modulo operator that gives a remainder when an integer x is divided by an integer y.

According to the equations (32) and (33), when there is a sample of the pulse compression signal F_{V·Ex}(h,m) corresponding to the sampling number h_{GCD} (when the modulo operator gives a zero value), the pulse compression signal F_{V·Ex}(h,m) is output, and when there is no sample of the pulse compression signal F_{V·Ex}(h,m) corresponding to the sampling number h_{GCD} (when the modulo operator gives a non-zero value), a zero value is output.

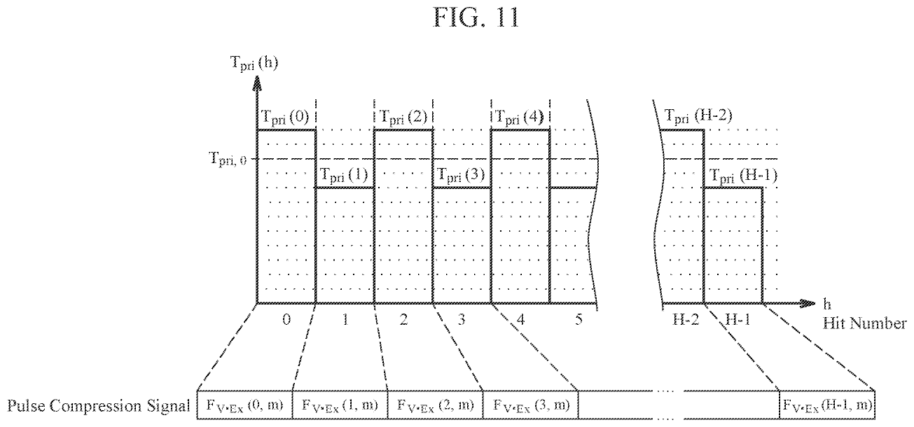

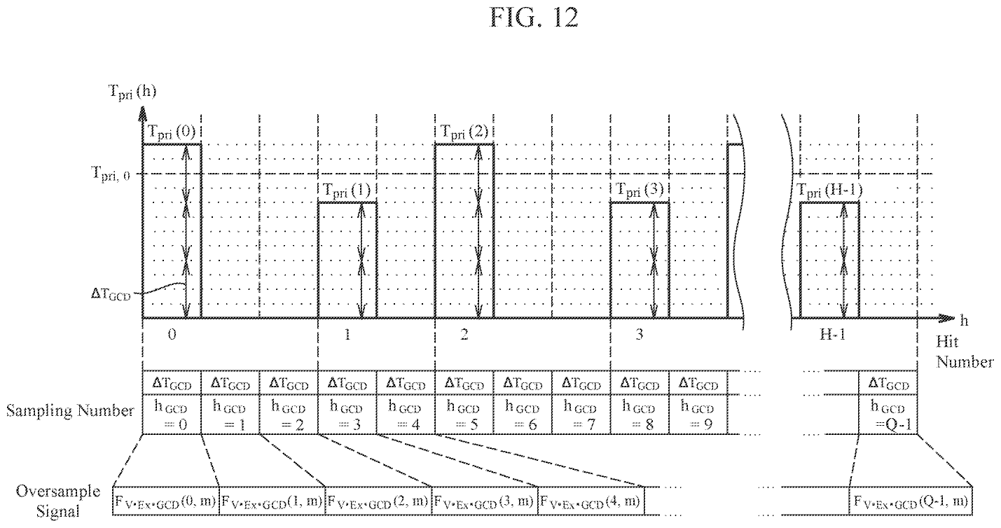

FIG. 11 is an explanatory diagram schematically showing a relationship between the hit number h, the pulse repetition interval Tₚᵣᵢ(h), and the pulse compression signal F_{V·Ex}(h,m). The pulse compression signals F_{V·Ex}(0,m),F_{V·Ex}(1,m), . . . , F_{V·Ex}(H−1,m) correspond to the unequally spaced pulse repetition intervals Tₚᵣᵢ(0), Tₚᵣᵢ(1), . . . , Tₚᵣᵢ(H−1), respectively. FIG. 12 is an explanatory diagram schematically showing a relationship between the hit number h, the pulse repetition interval Tₚᵣᵢ(h), the sampling number h_{GCD}, and the oversample signal F_{V·Ex·GCD}(h_{GCD},m). As shown in FIG. 12, an even-numbered pulse repetition interval Tₚᵣᵢ(h) has three times the length of the greatest common divisor ΔT_{GCD}, and an odd-numbered pulse repetition interval Tₚᵣᵢ(h) has twice the length of the greatest common divisor ΔT_{GCD}. For the even-numbered pulse repetition interval Tₚᵣᵢ(h), oversampling is performed at a rate of three times, so that output data points that are three times the input data points are generated. For the odd-numbered pulse repetition interval Tₚᵣᵢ(h), oversampling is performed at a double rate, so that output data points that are twice the input data points are generated. When the oversampling by the equations (32) and (33) is performed, oversample signals F_{V·Ex·GCD}(0,m) to F_{V·Ex·GCD}(4,m) are as follows.

F_{V·Ex·GCD}(0,m)=F_{V·Ex}(0,m),

F_{V·Ex·GCD}(1,m)=0,

F_{V·Ex·GCD}(2,m)=0,

F_{V·Ex·GCD}(3,m)=F_{V·Ex}(1,m),

F_{V·Ex·GCD}(4,m)=0.

Note that the oversampling unit 43 may output the oversample signal F_{V·Ex·GCD}(h_{GCD},m) obtained by the equation (33) to the domain conversion unit 45 as it is, but it is not limited thereto. By using a digital filter such as an FIR (Finite Impulse Response) filter, the oversampling unit 43 may filter the oversample signal F_{V·Ex·GCD}(h_{GCD},m) obtained by the equation (33) to calculate a filter signal, and output the filter signal to the domain conversion unit 45.

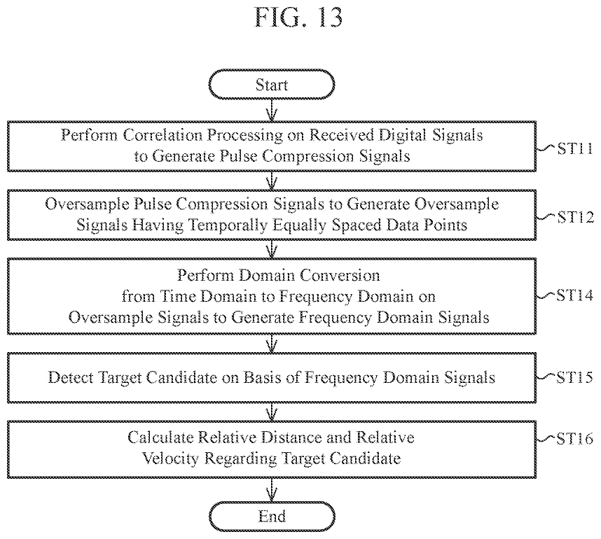

Next, FIG. 13 is a flowchart schematically showing an operation procedure of the radar signal processing circuit 31 in the second embodiment. Hereinafter, operation of the radar signal processing circuit 31 in the present embodiment will be described by referring to FIG. 13.

First, as in the case of the first embodiment, when received digital signals V₀(h,m) are input, the correlation processing unit 42 generates pulse compression signals F_{V·Ex}(h,m) by performing correlation processing using a reference signal Ex(m) on the received digital signals V₀(h,m) (step ST11).

Next, the oversampling unit 43 generates oversample signals F_{V·Ex·GCD}(h_{GCD},m)(h_{GCD}=0 to Q−1) having data points that are temporally equally spaced in the pulse hit direction by oversampling the pulse compression signals F_{V·Ex}(h,m) (step ST12).

After that, the domain conversion unit 45 performs a discrete Fourier transform based on a predetermined algorithm such as a fast Fourier transform (FFT) or a Chirp Z-Transform (CZT) on the oversample signals F_{V·Ex·GCD}(h_{GCD},m) to generate frequency domain signals f_{d,GCD}(h_{fft},m) (step ST14). As the algorithm of the chirp z-transform, an algorithm using FFT such as a Bluestein's FFT algorithm may be used. The discrete

Fourier transform is expressed by the following equation (34).

$${f}_{d , GCD} ( {h}_{fft} , m ) = {\sum }_{{h}_{GCD} = 0}^{Q - 1} {F}_{V \cdot Ex , GCD} ( {h}_{GCD} , m ) exp ( - j 2 π \frac{{h}_{GCD}}{Q} {h}_{fft} ) \\ ( {h}_{fft} = 0 , 1 , … , Q - 1 ) \\ ( m = 0 , 1 , … , M ( h ) - 1 ) \qquad ( 34 )$$

In the equation (34), h_{fft} is an integer in the range of 0 to Q−1 representing a sampling number in a frequency domain, and Q is a discrete Fourier transform point.

When the discussion for deriving the equation (20) according to the first embodiment is applied, the following equation (35) is established as a condition for obtaining high integration efficiency in the discrete Fourier transform.

$${f}_{0} \frac{2 v Δ {T}_{GCD}}{c} - \frac{{h}_{fft}}{Q} ≅ 0 \qquad ( 35 )$$

Assuming that the sampling number h_{fft} satisfying the condition of the equation (35) is expressed as h_{fft,peak,GCD}, the sampling number h_{fft,peak,GCD} is expressed as shown in the following equation (36).

$${h}_{fft , peak , GCD} ≅ {f}_{0} \frac{2 v Δ {T}_{GCD}}{c} Q \qquad ( 36 )$$

Therefore, high integration efficiency can be obtained for the sampling number h_{fft,peak,GCD} in the frequency domain. At this time, a frequency range based on the greatest common divisor ΔT_{GCD} can be calculated on the basis of a velocity value v_{amb,GCD} in the following equation (37).

$${v}_{amb , GCD} = \frac{c}{2 {f}_{0} Δ {T}_{GCD}} \qquad ( 37 )$$

When the domain conversion unit 45 performs the discrete Fourier transform based on the known charp z-transform (CZT) algorithm using the FFT, the discrete Fourier transform can be performed only for a desired Doppler frequency range, so that a calculation amount can be reduced. For example, as shown in the following equation (38), the frequency domain signal f_{d,GCD}(h_{fft},m) may be generated by performing the discrete Fourier transform based on the CZT algorithm in a range between the minimum Doppler frequency corresponding to the velocity value −v_{amb,0}/2 and the maximum Doppler frequency corresponding to the velocity value +v_{amb,0}/2.

$${f}_{d , GCD} ( {h}_{fft} , m ) = CZT ( {F}_{V \cdot Ex \cdot GCD} ( {h}_{GCD} , m ) , - \frac{{v}_{amb , 0}}{2} , \frac{{v}_{amb , 0}}{2} ) \\ ( {h}_{fft} = 0 , 1 , … , Q - 1 ) \\ ( m = 0 , 1 , … , M ( h ) - 1 ) \qquad ( 38 )$$

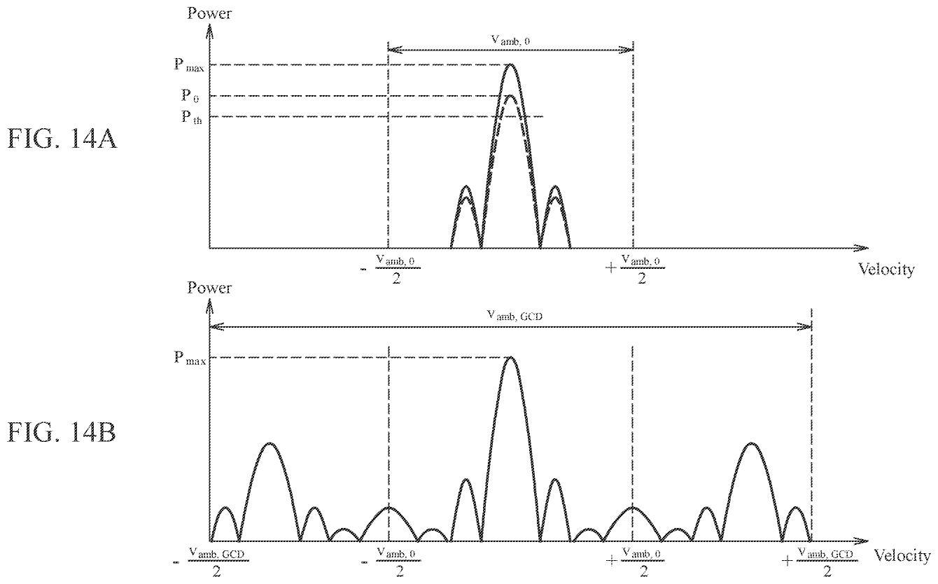

FIG. 14A is a diagram schematically showing an example of spectra of frequency domain signals f_{d}(h_{fft},m) generated in the first embodiment, and FIG. 14B is a diagram schematically showing an example of a spectrum of the frequency domain signal f_{d,GCD}(h_{fft},m) generated in the second embodiment. In graphs of FIGS. 14A and 14B, a horizontal axis represents velocity corresponding to the Doppler frequency and a vertical axis represents power. In FIG. 14A, a solid line represents the spectrum of the frequency domain signal obtained when there is no integration loss, and a broken line represents the spectrum of the frequency domain signal f_{d}(h_{fft},m) according to the first embodiment. Further, in FIG. 14B, a solid line represents the spectrum of the frequency domain signal f_{d,GCD}(h_{fft},m) according to the second embodiment. In FIG. 14A, it can be seen that the desired power P₀, which is smaller than the maximum power Pₘₐₓ and larger than the threshold power Pₜₕ, is obtained. In FIG. 14B, the power obtained is almost equal to the maximum power Pₘₐₓ.

Note that also in the first embodiment, the domain conversion unit 44 may perform the discrete Fourier transform based on the known algorithm of the chirp z-transform.

After the execution of step ST14, the target candidate detection unit 51 detects a target candidate on the basis of signal strength of the frequency domain signals f_{d,GCD}(h_{fft},m), as in the case of the first embodiment (step ST15 in FIG. 13). At this time, the target candidate detection unit 51 can output, to the target candidate information calculating unit 52, a target candidate number ntg assigned to the detected single or plurality of target candidate(s), a sampling number m=m_{ntg} corresponding to the target candidate number ntg, and a sampling number h_{fft}=h_{fft,ntg} of the frequency domain corresponding to the target candidate number ntg.

Next, as in the case of the first embodiment, the target candidate information calculating unit 52 calculates a relative distance and relative velocity regarding the target candidate, and outputs data indicating the relative distance and the relative velocity to the display 60 (step ST16 in FIG. 13). At this time, the target candidate information calculating unit 52 can calculate relative velocity V_{0,ntg} of the ntg-th target candidate according to the following equation (39) using a sampling interval Δv_{fft} shown in the following equation (40).

$$\begin{matrix}{V}_{0 , ntg} = {h}_{fft , ntg} Δ {v}_{fft} \\ ( {n}_{tgt} = 1 , … , {N}_{tgt} ) & ( 39 ) \\ Δ {v}_{fft} = \frac{c}{2 {f}_{0} Δ {T}_{GCD} Q} {h}_{fft , ntg} & ( 40 )\end{matrix}$$

Here, for convenience of explanation, the target candidate number ntg takes an integer in the range of 1 to N_{tgt}.

As described above, in the second embodiment, the oversample signals F_{V·Ex·GCD}(h_{GCD},m) having the data points that are temporally equally spaced in the pulse hit direction are generated using the greatest common divisor ΔT_{GCD} of the pulse repetition intervals Tₚᵣᵢ(0) to Tₚᵣᵢ(H−1), and the discrete Fourier transform is performed on the oversample signals F_{V·Ex·GCD}(h_{GCD},m), so that compared with the first embodiment, it is possible to further suppress the integration loss. Therefore, it is possible to provide the radar apparatus 2 which achieves high integration efficiency and a high SNR and has improved target detection performance.

Note that a hardware configuration of the PRI control unit 15 and the radar signal processing circuit 31 in the second embodiment may be implemented by an LSI such as an ASIC or an FPGA. As in the case of the first embodiment, the hardware configuration of the PRI control unit 15 and the radar signal processing circuit 31 in the second embodiment may be implemented by the signal processing circuit 70 shown in FIG. 9. Further, the PRI control unit 15 is a component different from the signal generation circuit 10, but is not limited to this. The PRI control unit 15 may be incorporated in the signal generation circuit 10 or the radar signal processing circuit 31.

### Third Embodiment

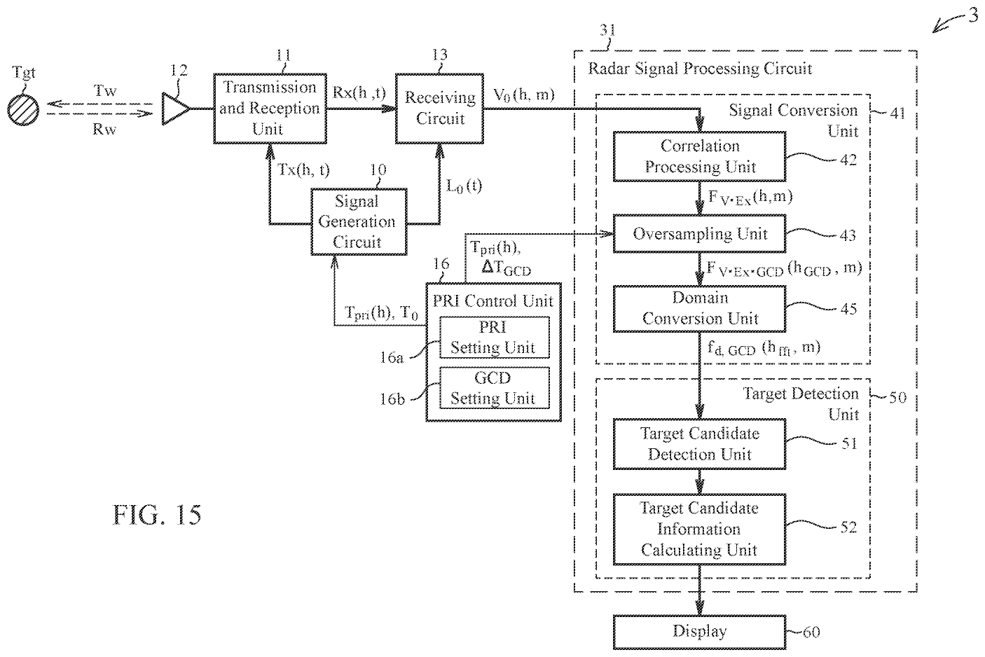

FIG. 15 is a block diagram schematically showing a configuration of a radar apparatus 3 according to a third embodiment of the present invention. The configuration of the radar apparatus 3 in the present embodiment is the same as the configuration of the radar apparatus 2 in the second embodiment, except that a PRI control unit 16 in FIG. 15 is provided in place of the PRI control unit 15 in the second embodiment.

The PRI control unit 16 in the present embodiment includes a PRI setting unit 16a and a GCD setting unit 16b. The PRI setting unit 16a supplies a pulse width T₀ and a series of unequally spaced pulse repetition intervals Tₚᵣᵢ(0) to Tₚᵣᵢ(H−1) to a signal generation circuit 10. The series of pulse repetition intervals Tₚᵣᵢ(0) to Tₚᵣᵢ(H−1) is not limited to a pair of a pulse repetition interval longer than a reference interval T_{pri,0} and a pulse repetition interval shorter than the reference interval T_{pri,0}. For example, the PRI setting unit 16a can set a random or pseudo-random value as a value of the pulse repetition intervals Tₚᵣᵢ(0) to Tₚᵣᵢ(H−1). Here, the GCD setting unit 16b may calculate a set value of the greatest common divisor ΔT_{GCD}, or may use a data value stored in advance in a memory as the set value of the greatest common divisor ΔT_{GCD}. The value of the greatest common divisor ΔT_{GCD} may be expressed as an integer or a decimal number. Further, the value of the greatest common divisor ΔT_{GCD} may be calculated with accuracy that can obtain a desired suppression amount of integration loss and a desired signal-to-noise ratio.

Similarly to the GCD setting unit 15b in the second embodiment, the GCD setting unit 16b sets the greatest common divisor ΔT_{GCD} of the series of pulse repetition intervals Tₚᵣᵢ(0) to Tₚᵣᵢ(H−1), and supplies the greatest common divisor ΔT_{GCD} to an oversampling unit 43 of a signal conversion unit 41.

The oversampling unit 43 in the present embodiment uses the greatest common divisor ΔT_{GCD}, and converts pulse compression signals F_{V·Ex}(h,m)(h=0 to H−1) having H data points that are temporally unequally spaced in a pulse hit direction into oversample signals F_{V·Ex·GCD}(h_{GCD},m)(h_{GCD}=0 to Q−1) having Q data points that are temporally equally spaced in the pulse hit direction. Similarly to the second embodiment, a domain conversion unit 45 in the present embodiment can perform a discrete Fourier transform based on an algorithm of a fast Fourier transform (FFT) or an algorithm of a charp z-transform (CZT) on the oversample signal F_{V·Ex·GCD}(h_{GCD},m) to generate a frequency domain signal f_{d,GCD}(h_{fft},m). As the algorithm of the chirp z-transform, an algorithm using FFT such as a Bluestein's FFT algorithm may be used. As a result, the domain conversion unit 45 can perform an accurate discrete Fourier transform on the oversample signal F_{V·Ex·GCD}(h_{GCD},m).

As described above, in the third embodiment, the oversample signals F_{V·Ex·GCD}(h_{GCD},m) having the data points that are temporally equally spaced in the pulse hit direction are generated using the greatest common divisor ΔT_{GCD} of the unequally spaced pulse repetition intervals Tₚᵣᵢ(0) to Tₚᵣᵢ(H−1), and the discrete Fourier transform is performed on the oversample signals F_{V·Ex·GCD}(h_{GCD},m), so that it is possible to suppress the integration loss. Therefore, it is possible to provide the radar apparatus 3 which achieves high integration efficiency and a high SNR and has improved target detection performance.

Note that a hardware configuration of the PRI control unit 16 and a radar signal processing circuit 31 in the third embodiment may be implemented by an LSI such as an ASIC or an FPGA. As in the case of the first embodiment, the hardware configuration of the PRI control unit 16 and the radar signal processing circuit 31 in the third embodiment may be implemented by the signal processing circuit 70 shown in FIG. 9. Further, the PRI control unit 16 is a component different from the signal generation circuit 10, but is not limited thereto. The PRI control unit 16 may be incorporated in the signal generation circuit 10 or the radar signal processing circuit 31.

### Fourth Embodiment

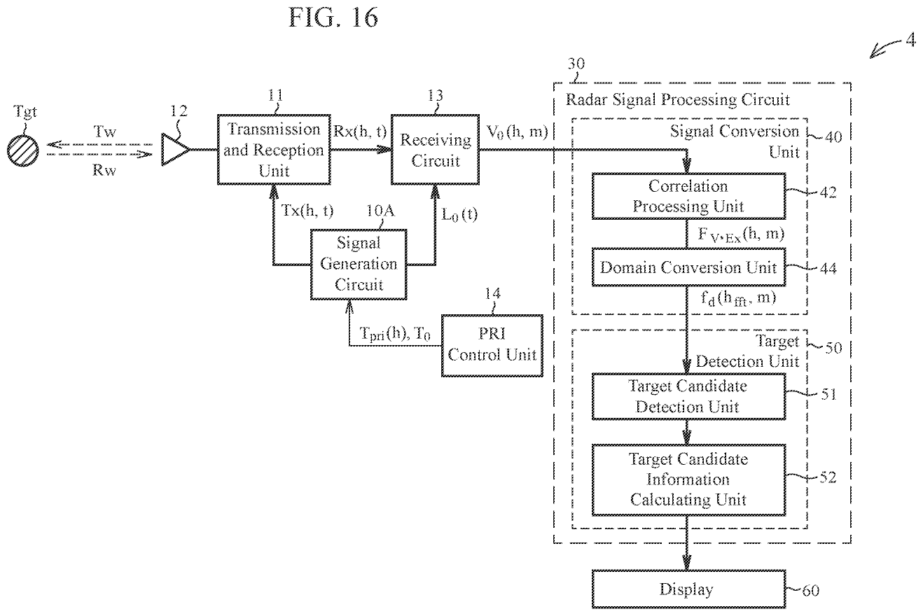

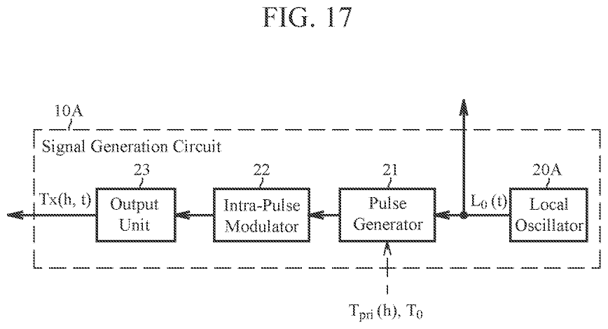

FIG. 16 is a block diagram schematically showing a configuration of a radar apparatus 4 according to a fourth embodiment of the present invention. The configuration of the radar apparatus 4 in the present embodiment is the same as the configuration of the radar apparatus 1 in the first embodiment, except that a signal generation circuit 10A is provided instead of the signal generation circuit 10 in the first embodiment. FIG. 17 is a schematic configuration diagram of the signal generation circuit 10A. The configuration of the signal generation circuit 10A is the same as the configuration of the signal generation circuit 10 in the first embodiment, except that a local oscillator 20A shown in FIG. 17 is provided instead of the local oscillator 20 in the first embodiment.

In the present embodiment, the local oscillator 20A shown in FIG. 17 generates a local oscillation signal L₀(t) whose oscillation frequency changes due to frequency hopping as shown in the following equation (41).

Lₒ(t)=A_{L} exp(j(2π(f₀+hB₀)t+ϕ₀))

(0≤t<T_{obs})

(h=0,1, . . . , H−1) (41)

Here, t is time, A_{L} is amplitude of the local oscillation signal L₀(t), f₀ is center frequency, h is a hit number, B₀ is a modulation bandwidth, φ₀ is an initial phase of the local oscillation signal L₀(t), T_{obs} is an upper limit of an observation period, and j is an imaginary unit.

At this time, a transmission and reception unit 11 outputs a reflected wave signal Rx(h,t) as shown in the following equation (42) instead of the above equation (8).

$$Rx ( h , t ) = \\ \{ \begin{matrix}{A}_{R} exp ( j \{ 2 π [ ( {f}_{0} + {hB}_{0} ) ( τ - \frac{2 ( {R}_{0} - vt )}{c} ) + \frac{{B}_{0}}{2 {T}_{0}} {( τ - \frac{2 ( {R}_{0} - vt )}{c} )}^{2} ] + {φ}_{0} \} ) , & t ∈ Λ [ h ] \\ 0 , & t ∉ Λ [ h ]\end{matrix} \qquad ( 42 )$$

A configuration of a receiving circuit 13 in the present embodiment is the same as that of the receiving circuit 13 (FIG. 5) in the first embodiment. A phase detector 27 of the receiving circuit 13 in the present embodiment can generate a detection signal as shown in the following equation (43), instead of the above equation (10), as a received analog signal W₀(h,t).

$${W}_{0} ( h , t ) = Rx ( h , t ) {L}_{0}^{*} ( t ) = \\ \{ \begin{matrix}{A}_{V} exp ( j 2 π [ - ( {f}_{0} + {hB}_{0} ) \frac{2 ( {R}_{0} - vt )}{c} + \frac{{B}_{0}}{2 {T}_{0}} {( τ - \frac{2 ( {R}_{0} - vt )}{c} )}^{2} ] ) , & t ∈ Λ [ h ] \\ 0 , & t ∉ Λ [ h ]\end{matrix} \\ ( h = 0 , 1 , … , H - 1 )$$

Furthermore, an A/D converter 28 of the receiving circuit 13 in the present embodiment can generate a received digital signal (received video signal) V₀(h,m) as shown in the following equation (44), instead of the above equation (11).

$${V}_{0} ( h , m ) = \\ \{ \begin{matrix}A exp ( - j 2 π ( {f}_{0} + {hB}_{0} ) \cdot 2 ( {R}_{0} - v ( {\sum }_{n = - 1}^{h - 1} {T}_{pri} ( n ) + m Δ t ) ) / c ) & \\ exp ( j 2 π \frac{{B}_{0}}{2 {T}_{0}} {( m Δ t - 2 ( {R}_{0} - v ( {\sum }_{n = - 1}^{h - 1} {T}_{pri} ( n ) m Δ t ) ) / c )}^{2} ) & m ∈ Ψ [ h ] \\ 0 , & m ∉ Ψ [ h ] \end{matrix} \\ ( m = 0 , 1 , … , M ( h ) - 1 ) \\ ( h = 0 , 1 , … , H - 1 ) \qquad ( 44 )$$

The equation (44) is an equation obtained when ascending frequency hopping is performed. A first term of a product on a right side of the equation (44) includes a parameter “hB₀” indicating a product of the modulation bandwidth B₀ and the hit number h. When descending frequency hopping is performed, the parameter “hB₀” is replaced with “−hB₀”.

At this time, a domain conversion unit 44 can generate a frequency domain signal f_{d}(h_{fft},m) as shown in the following equation (45) by performing a discrete Fourier transform on a pulse compression signal F_{V·Ex}(h,m).

$${f}_{d} ( {h}_{fft} , m ) = {\sum }_{h = 0}^{H - 1} A exp ( - j 2 π ( {f}_{0} + {hB}_{0} ) \cdot 2 ( {R}_{0} - v ( {\sum }_{n = - 1}^{h - 1} {T}_{pri} ( n ) + m Δ t ) ) / c ) exp ( - j 2 π \frac{h}{H} {h}_{fft} ) \qquad ( 45 )$$

As in the case of the first embodiment, the following equation (46) can be obtained by deforming the equation (45).

$${f}_{d} ( {h}_{fft} , m ) = exp ( - j 2 π {f}_{0} \frac{2 {R}_{0}}{c} ) exp ( - j 2 π {f}_{0} \frac{2 vm Δ t}{c} ) \\ {\sum }_{h = 0}^{H - 1} A exp ( j 2 π ( - {hB}_{0} \frac{2 {R}_{0}}{c} + {f}_{0} \cdot 2 v {\sum }_{n = - 1}^{h - 1} {T}_{pri} ( n ) / c - \frac{h}{H} {h}_{fft} ) ) \qquad ( 46 )$$

The right side of the equation (46) consists of a product of three terms. When magnitude of a value of a third term of the product on the right side is maximized, high integration efficiency can be obtained in the discrete Fourier transform. A condition that the magnitude of the value of the third term is almost maximized is as shown in the following equation (47).

$$- {hB}_{0} \frac{2 {R}_{0}}{c} + {f}_{0} \cdot 2 v {\sum }_{n = - 1}^{h - 1} {T}_{pri} ( n ) / c - \frac{h}{H} {h}_{fft} ≅ 0 \qquad ( 47 )$$

When an average value of the pulse repetition intervals Tₚᵣᵢ(h) on the left side of the equation (47) substantially matches a reference interval T_{pri,0}, the equation (47) is expressed by the following equation (48).

$$- {B}_{0} \frac{2 {R}_{0}}{c} + {f}_{0} \frac{2 {vT}_{pri , 0}}{c} - \frac{{h}_{fft}}{H} ≅ 0 \qquad ( 48 )$$

Assuming that a sampling number h_{fft} satisfying a condition of the equation (48) is expressed as h_{fft,peak}, the sampling number h_{fft,peak} is expressed as shown in the following equation (49).

$${h}_{fft , peak} ≅ ( - {B}_{0} \frac{2 {R}_{0}}{c} + {f}_{0} \frac{2 {vT}_{pri , 0}}{c} ) H \qquad ( 49 )$$

As described above, in the fourth embodiment, since the frequency hopping is used, it is possible to provide the radar apparatus 4 that further suppresses radio wave interference with other radar systems and lowers detected performance of the other radar systems.

Note that a hardware configuration of a PRI control unit 14 and a radar signal processing circuit 30 in the fourth embodiment may be implemented by an LSI such as an ASIC or an FPGA. As in the case of the first embodiment, the hardware configuration of the PRI control unit 14 and the radar signal processing circuit 30 in the fourth embodiment may be implemented by the signal processing circuit 70 shown in FIG. 9.

Although the first to fourth embodiments according to the present invention have been described above by referring to the drawings, the first to fourth embodiments are examples of the present invention, and there can be various other embodiments other than the first to fourth embodiments. The present invention can freely combine the first to fourth embodiments, modify arbitrary components in the first to fourth embodiments, or omit arbitrary components in the embodiments within the scope of the present invention. For example, in the configuration of the fourth embodiment, there can be a modified example in which the oversampling unit 43 in the second embodiment is incorporated, the PRI control unit 15 in the second embodiment or the PRI control unit 16 in the third embodiment is incorporated instead of the PRI control unit 14, and the domain conversion unit 45 in the second embodiment is incorporated instead of the domain conversion unit 44.

Further, in each of the first to fourth embodiments, there can be a modified example in which there is no intra-pulse modulation and correlation processing. In this case, the radar signal processing circuits 30 and 31 in the first to fourth embodiments are modified so as not to have the correlation processing unit 42. Further, the domain conversion unit 44 in the first embodiment or the fourth embodiment may be modified so as to perform a discrete Fourier transform based on a predetermined algorithm on the received digital signal V₀(h,m) to generate a frequency domain signal f_{d}(h_{fft},m). Furthermore, the oversampling unit 43 in the second embodiment or the third embodiment may convert received digital signals V₀(h,m)(h=0 to H−1) having data points that are temporally unequally spaced regarding the hit number h into the oversample signals F_{V·Ex·GCD}(h_{GCD},m)(h_{GCD}=0 to Q−1) having the data points that are temporally equally spaced.

### INDUSTRIAL APPLICABILITY

The radar apparatus and the signal processing method according to the present invention can be used in a radar system that detects a relative position and relative velocity of a target such as a mobile target. Further, the radar apparatus according to the present invention can be used in a state of being installed on the ground or in a state of being mounted on a mobile object such as an aircraft, an artificial satellite, a vehicle, or a ship.

### REFERENCE SIGNS LIST

1, 2, 3, 4: radar apparatus, 10, 10A: signal generation circuit, 11: transmission and reception unit, 12: antenna, 13: receiving circuit, 14, 15, 16: PRI control unit, 20: local oscillator, 21: pulse generator, 22, 22A: intra-pulse modulator, 23: output unit, 24: down converter, 25: band filter, 26: amplifier, 27: phase detector, 28: A/D converter, 30, 31: radar signal processing circuit, 40, 41: signal conversion unit, 42: correlation processing unit, 44, 45: domain conversion unit, 50: target detection unit, 51: target candidate detection unit, 52: target candidate information calculating unit, 60: display, 70: signal processing circuit, 71: processor, 72: memory, 73: storage device, 74: input and output interface, 75: signal path, Tgt: target, Tw: transmission wave, Rw: reflected wave

1. A radar apparatus comprising:
processing circuitry to
set a plurality of pairs of a pulse repetition interval longer than a predetermined reference interval and a pulse repetition interval shorter than the reference interval;
continuously generate a plurality of transmission pulse signals at a timing based on the plurality of pairs of pulse repetition intervals;
send out the plurality of transmission pulse signals to external space and receiving a plurality of reflected wave signals corresponding to the respective plurality of transmission pulse signals from the external space;
generate a plurality of received signals corresponding to the respective plurality of transmission pulse signals by sampling each of the plurality of reflected wave signals having been received;
generate a plurality of frequency domain signals by performing domain conversion processing from a time domain to a frequency domain on the plurality of received signals; and
detect a target candidate on a basis of the plurality of frequency domain signals.

2. The radar apparatus according to claim 1, wherein each pair of the plurality of pairs includes a pair of pulse repetition intervals each having symmetrical values about the reference interval, and an average value of the pulse repetition intervals constituting each pair matches the reference interval.

3. The radar apparatus according to claim 2, wherein each pair includes two continuous pulse repetition intervals.

4. The radar apparatus according to claim 1, wherein the processing circuitry performs a discrete Fourier transform as the domain conversion processing.

5. The radar apparatus according to claim 4, wherein the discrete Fourier transform is performed on a basis of an algorithm of a fast Fourier transform.

6. The radar apparatus according to claim 4, wherein the discrete Fourier transform is performed on a basis of an algorithm of a chirp z-transform.

7. The radar apparatus according to claim 1, wherein
the processing circuitry further generates
a plurality of oversample signals each having a data point, the data points being temporally equally spaced, by performing oversampling in a pulse hit direction on the plurality of received signals using a greatest common divisor of the plurality of pairs of pulse repetition intervals and
generates the plurality of frequency domain signals by performing the domain conversion processing on the plurality of oversample signals.

8. The radar apparatus according to claim 7, wherein the processing circuitry performs the oversampling, for each pulse repetition intervals of the plurality of pairs of pulse repetition intervals, at a ratio obtained by dividing each pulse repetition interval by the greatest common divisor.

9. The radar apparatus according to claim 1, wherein
the processing circuitry
generates a plurality of pulse signals from a local oscillation signal at a timing based on the plurality of pairs of pulse repetition intervals and
generates the plurality of transmission pulse signals by performing intra-pulse modulation on each of the plurality of pulse signals, and
the processing circuitry
generates a plurality of pulse compression signals by performing correlation processing using a reference signal for the plurality of received signal and
generates the plurality of frequency domain signals by performing the domain conversion processing on the plurality of pulse compression signals.

10. The radar apparatus according to claim 1, wherein
the processing circuitry
generates a plurality of pulse signals from a local oscillation signal at a timing based on the plurality of pairs of pulse repetition intervals and
generates the plurality of transmission pulse signals by performing intra-pulse modulation on each of the plurality of pulse signals, and
the processing circuitry
generates a plurality of pulse compression signals by performing correlation processing using a reference signal for the plurality of received signals,
generates a plurality of oversample signals each having a data point, the data points being temporally equally spaced, by performing oversampling in a pulse hit direction on the plurality of pulse compression signals using a greatest common divisor of the plurality of pairs of pulse repetition intervals and
generates the plurality of frequency domain signals by performing the domain conversion processing on the plurality of oversample signals.

11. The radar apparatus according to claim 10, wherein the processing circuitry performs the oversampling, for each pulse repetition interval of the plurality of pairs of pulse repetition intervals, at a ratio obtained by dividing each pulse repetition interval by the greatest common divisor.

12. The radar apparatus according to claim 1, wherein the processing circuitry generates the plurality of transmission pulse signals from a local oscillation signal whose oscillation frequency changes due to frequency hopping.

13. A radar apparatus comprising:
processing circuitry to
set a series of pulse repetition intervals and setting a greatest common divisor of the series of pulse repetition intervals;
continuously generate a plurality of transmission pulse signals at a timing based on the series of pulse repetition intervals;
send out the plurality of transmission pulse signals to external space and receiving a plurality of reflected wave signals corresponding to the respective plurality of transmission pulse signals from the external space;
generate a plurality of received signals corresponding to the respective plurality of transmission pulse signals by sampling each of the plurality of reflected wave signals having been received;
generate a plurality of frequency domain signals from the plurality of received signals; and
detect a target candidate on a basis of the plurality of frequency domain signals,
wherein the processing circuitry
generates a plurality of oversample signals each having a data point, the data points being temporally equally spaced, by performing oversampling in a pulse hit direction on the plurality of received signals using the greatest common divisor and
generates the plurality of frequency domain signals by performing domain conversion processing from a time domain to a frequency domain on the plurality of oversample signals.

14. The radar apparatus according to claim 13, wherein the series of pulse repetition intervals is not equally spaced.

15. The radar apparatus according to claim 13, wherein the processing circuitry performs a discrete Fourier transform based on an algorithm of a fast Fourier transform as the domain conversion processing.

16. The radar apparatus according to claim 13, wherein the processing circuitry performs a discrete Fourier transform based on an algorithm of a chirp z-transform as the domain conversion processing.

17. A signal processing method performed by a radar apparatus including a signal generation circuit for continuously generating a plurality of transmission pulse signals at a timing based on a given series of pulse repetition intervals, and a transceiver for sending out the plurality of transmission pulse signals to external space and receiving a plurality of reflected wave signals corresponding to the respective plurality of transmission pulse signals from the external space, the signal processing method comprising:
setting a plurality of pairs of a pulse repetition interval longer than a predetermined reference interval and a pulse repetition interval shorter than the reference interval;
providing the plurality of pairs of pulse repetition intervals for the signal generation circuit as the series of pulse repetition intervals;
generating a plurality of received signals corresponding to the respective plurality of transmission pulse signals by sampling each of the plurality of reflected wave signals received by the transceiver;
generating a plurality of frequency domain signals by performing domain conversion processing from a time domain to a frequency domain on the plurality of received signals; and
detecting a target candidate on a basis of the plurality of frequency domain signals.

18. The signal processing method according to claim 17, wherein each pair of the plurality of pairs includes a pair of pulse repetition intervals each having symmetrical values about the reference interval, and an average value of the pulse repetition intervals constituting each pair matches the reference interval.

19. A signal processing method performed by a radar apparatus including a signal generation circuit for continuously generating a plurality of transmission pulse signals at a timing based on a given series of pulse repetition intervals, and a transceiver for sending out the plurality of transmission pulse signals to external space and receiving a plurality of reflected wave signals corresponding to the respective plurality of transmission pulse signals from the external space, the signal processing method comprising:
setting the series of pulse repetition intervals;
setting a greatest common divisor of the series of pulse repetition intervals;
generating a plurality of received signals corresponding to the respective plurality of transmission pulse signals by sampling each of the plurality of reflected wave signals received by the transceiver;
generating a plurality of oversample signals each having a data point, the data points being temporally equally spaced, by performing oversampling in a pulse hit direction on the plurality of received signals using the greatest common divisor;
generating a plurality of frequency domain signals by performing domain conversion processing from a time domain to a frequency domain on the plurality of oversample signals; and
detecting a target candidate on a basis of the plurality of frequency domain signals.

20. The signal processing method according to claim 19, wherein the series of pulse repetition intervals is not equally spaced.
